(19) United States
(12) Patent Application Publication
(10) Pub. No.: US 2026/0010796 A1
(43) Pub. Date: Jan. 8, 2026

(54) NEURAL NETWORK-BASED METHOD AND SYSTEM FOR GENERATING OPTIMIZED EXECUTION PLANS FOR AI WORKLOADS IN HYBRID AND MULTI-CLOUD ENVIRONMENTS

(71) Applicant: MEGAZONE CLOUD CORPORATION, Seoul (KR)

(72) Inventors: Gwon Soo CHE, Seoul (KR); Min Joo KANG, Hanam-si (KR); Young Kook CHO, Seoul (KR)

(73) Assignee: MEGAZONE CLOUD CORPORATION, Seoul (KR)

(21) Appl. No.: 19/320,660

(22) Filed: Sep. 5, 2025

Related U.S. Application Data
(63) Continuation of application No. PCT/KR2024/012902, filed on Aug. 28, 2024.

(30) Foreign Application Priority Data
Jul. 8, 2024 (KR) 10-2024-0089402

(51) Int. Cl. G06N 3/091

(52) U.S. Cl. CPC G06N 3/091

(57) ABSTRACT

A neural network-based method and system for generating an optimized execution plan for AI workloads in hybrid and multi-cloud environments. The neural network-based method of generating an optimized execution plan for AI workloads in hybrid and multi-cloud environments according to the disclosure may include: receiving, from a user terminal, user AI workload definition information and user optimization requirement specification information; sampling information on different cloud environments and different network paths to generate a plurality of sample group data comprising the different cloud environments and the different network paths; inputting each of the plurality of sample group data into a neural network to receive a plurality of predicted values for the plurality of sample group data from the neural network; and specifying an optimal predicted value that satisfies the user AI workload definition information and the user optimization requirement specification information using optimal prediction calculation.

### TECHNICAL FIELD

The disclosure relates to a neural network-based method and system for generating an optimized execution plan for AI workloads in hybrid and multi-cloud environments.

The disclosure has been carried out as part of a research project supported by the Ministry of Trade, Industry and Energy and managed by the Korea Institute for the Advancement of Technology, titled “World Class Plus Project Support.” The project's unique number is 1415189612, and the project number is P0024391. The name of this research project is “Development of Intelligent MLOps Workload Management Tool Technology Based on Hybrid Cloud,” and MegazoneCloud Corporation is participating as the executing organization, with the project being conducted from Apr. 1, 2023, to Dec. 31, 2026.

### BACKGROUND ART

Recently, as the amount of computing resources required by artificial intelligence workloads is increasing, it is important to efficiently scale cloud infrastructure.

Accordingly, cases of constructing artificial intelligence workloads in hybrid cloud and multi-cloud environments are increasing.

A hybrid cloud refers to a cloud environment in which multiple workloads or one workload is formed by being mixed between a public cloud and a private cloud, whereas a multi-cloud refers to a cloud environment configured by using cloud computing services of two or more public cloud service providers.

Hybrid cloud and multi-cloud are more advantageous in terms of infrastructure scalability, and have an advantage in that a cloud environment may be configured by taking only the strengths of cloud servers provided by each cloud service provider.

However, if artificial intelligence workloads are not deployed to optimal cloud locations, resource and cost waste may occur. Here, the optimal location refers to a location that minimizes idle resources, cost, and time required for execution.

However, from the user's perspective, it is difficult to directly find and deploy the optimal location, resulting in frequent waste of cloud resources. Further, for optimal workload deployment, it is important to find and deploy a cloud environment that is suitable for the characteristics of the workload, cost, and processing speed in consideration thereof, but the current systems fail to provide satisfactory functionality for this.

Further, conventionally, there are limitations in that information that affects the actual workload execution cost, such as the characteristics of the user AI workload itself and the network transmission path information, is not sufficiently reflected.

### Technical Problem

The disclosure is directed to providing a neural network-based method and system for generating an optimized execution plan for AI workloads in hybrid and multi-cloud environments.

More specifically, the disclosure is directed to providing a neural network-based method and system for generating an optimized execution plan for AI workloads in hybrid and multi-cloud environments, which may calculate an optimized execution plan for AI workloads in hybrid and multi-cloud environments by receiving, as input, not only cloud environment information but also user AI workload definition information and network path information.

In addition, the disclosure is directed to providing a neural network-based method and system for generating an optimized execution plan for AI workloads in hybrid and multi-cloud environments, which may systematically manage heterogeneous cloud environments based on unified information values.

Further, the disclosure is directed to providing a neural network-based method and system for generating an optimized execution plan for AI workloads in hybrid and multi-cloud environments, which may recommend an optimal cloud environment that satisfies the user's requirement conditions.

### Advantageous Effects

As described above, the neural network-based method and system for generating an optimized execution plan for AI workloads in hybrid and multi-cloud environments according to the disclosure may achieve a better optimized execution point for AI workloads in hybrid and multi-cloud environments and maximize execution efficiency, by integrally considering elements that affect the optimized execution of AI workloads (e.g., user AI workload definition information, cloud environment information, network path information, etc.) and the user's requirements.

In addition, as the neural network-based method and system for generating an optimized execution plan for AI workloads in hybrid and multi-cloud environments according to the disclosure selects an optimal cloud environment and network path suited to the characteristics of the AI workload and the user's requirements and provides it to the user, the user may maximize the efficient usage of time, cost, and resource required to execute AI workloads.

More specifically, the neural network-based method and system for generating an optimized execution plan for AI workloads in hybrid and multi-cloud environments according to the disclosure may recommend optimal cloud environment setting information to the user by comparing and analyzing the price and performance of various cloud service providers. Through this, the user may reduce the cost burden required to execute AI workloads and further optimize the time required for execution.

That is, the neural network-based method and system for generating an optimized execution plan for AI workloads in hybrid and multi-cloud environments according to the disclosure may provide the user with convenience in the construction of hybrid and multi-cloud environments, thereby enabling the user to stably operate the hybrid and multi-cloud environments.

Further, the neural network-based method and system for generating an optimized execution plan for AI workloads in hybrid and multi-cloud environments according to the disclosure may provide recommendation information on optimal cloud environment setting information that satisfies the user AI workload definition information and user optimization requirement specification information. Through this, the user may select an optimal cloud environment and network path that simultaneously satisfy the optimization of time and cost required to execute the AI workload from various perspectives.

### DESCRIPTION OF DRAWINGS

FIGS. 1 and 2 are conceptual diagrams for describing a neural network-based system for generating an optimized execution plan for AI workloads in hybrid and multi-cloud environments according to the disclosure.

FIG. 3 is a flowchart for describing a neural network-based method of generating an optimized execution plan for AI workloads in hybrid and multi-cloud environments according to the disclosure.

FIGS. 4A, 4B, 4C, 5, 6, 7, 8, 9A, 9B, and 10 are conceptual diagrams for describing a neural network-based method of generating an optimized execution plan for AI workloads in hybrid and multi-cloud environments according to the disclosure.

FIGS. 11, 12, and 13 are conceptual diagrams for describing a method of recommending cloud environment setting information to the user according to the disclosure.

### DETAILED DESCRIPTION OF EMBODIMENTS

The disclosure relates to a neural network-based method and system for generating an optimized execution plan for AI workloads in hybrid and multi-cloud environments, which may receive, as input, not only cloud environment information, but also user AI workload definition information and network path information, calculate optimized execution data for AI workloads in hybrid and multi-cloud environments, and systematically manage heterogeneous cloud environments based on a unified (or consistent) intermediate representation.

The cloud environment information may include various elements related to the cloud computing infrastructure provided by cloud service providers. For example, the cloud environment information may include at least one of: cloud service providers (e.g., AWS, Azure, Google Cloud, etc.); cloud service locations (or regions); cloud service price (or cost) policies (e.g., cost information based on used resources, pricing factors, billing plans, discounts and benefits, etc.); cloud service types (e.g., infrastructure as a service (IaaS), platform as a service (PaaS), software as a service (SaaS), etc.); resource configurations (e.g., computing resources (virtual machines, containers, serverless computing, etc.); storage resources (block storage, file storage, object storage, etc.); network resources (virtual networks, load balancers, VPNs, and CDNs); resource state (e.g., state and usage status of virtual machines, storage, network, databases, etc.); resource deployment (e.g., deployed locations of virtual machines, containers, storage, etc.); security and compliance (e.g., firewalls, identity and access management (IAM), multi-factor authentication (MFA), encryption methods, security certifications, and regulatory compliance (GDPR, HIPAA, SOC 2, etc.); or operation and management (e.g., monitoring, automation, orchestration, etc.).

In addition, the network path information may include various elements related to network performance and network transmission paths required for transmitting and receiving data in cloud environments. For example, the network path information may include at least one of: network location (or region); network topology (e.g., network configuration diagrams, subnets, routing tables); routing information (e.g., routing protocols (BGP, OSPF), static routing); network devices (e.g., routers, switches, firewalls, etc.); IP address ranges (e.g., public IPs, private IPs, CIDR blocks, etc.); DNS settings (e.g., domain names, DNS servers, record types, etc.); network security (e.g., firewall rules, security groups, access control lists (ACLs), etc.); traffic management (e.g., quality of service (QOS), traffic shaping, CDNs, etc.); latency (e.g., network latency for each segment); bandwidth (e.g., maximum and average bandwidth usage per network path); packet loss rate (e.g., data packet loss rate per segment); or path optimization information (e.g., information required for path optimization, such as load balancing of network traffic, congestion avoidance, and bypass paths).

Further, the user AI workload definition information may include various elements required to perform a specific AI task. For example, the user AI workload definition information may include at least one of: workload type (e.g., training, inference, etc.); artificial intelligence (AI) model type (e.g., CNN, RNN, Transformer, etc.); artificial intelligence model architecture (e.g., structure of an artificial intelligence model (number of layers, number of nodes per layer, number of parameters, etc.), artificial intelligence algorithms, etc.); dataset characteristics (e.g., dataset size (capacity), format (CSV, image, text, etc.), data source (data lakes, databases, APIs), etc.); data pipeline (e.g., data preprocessing and postprocessing steps, data augmentation methods, etc.); execution environment (e.g., required software, frameworks such as TensorFlow, PyTorch, and Scikit-learn); training parameters (e.g., batch size, learning rate, number of epochs, etc.); computing resources (e.g., resource requirements for CPU, GPU, memory, storage, etc. that are required); artificial intelligence model performance targets (e.g., accuracy, precision, recall, etc.); inference requirements (e.g., real-time inference, batch inference, response time targets); deployment method (e.g. strategy for deploying models such deployment as real-time predictive services, deployment as batch tasks); or monitoring and logs (e.g., model performance monitoring, error logs, training process records, etc.).

However, the elements included in the cloud environment information, network path information, and user AI workload definition information in the disclosure are not limited thereto, and may further include various other elements not described above.

Meanwhile, a heterogeneous cloud may refer to a cloud computing method that integrates and uses different kinds of cloud environments and infrastructures. Such heterogeneous clouds may operate in environments where various types of cloud infrastructures are mixed, such as public cloud, private cloud, and on-premises. That is, heterogeneous clouds secure interoperability among various platforms and provide the function that enables the transfer or integration of data and applications across different environments.

In addition, a hybrid cloud may refer to a cloud environment in which multiple workloads or one workload is formed by being mixed between a public cloud and a private cloud (or on-premises infrastructure). A hybrid cloud connects on-premises and public cloud infrastructures, and is operated in a manner that stores sensitive data in a private cloud or on-premises, and utilizes the public cloud for workloads that require general data processing or scaling. That is, hybrid clouds may simultaneously achieve flexible resource scalability, cost efficiency, and security.

Further, multi-cloud may refer to a cloud environment configured by using cloud computing services from two or more public cloud service providers. This refers to a method of use that is not dependent on any one cloud service provider, but instead combines and utilizes cloud services provided by various cloud service providers. Each cloud service provider provides different functionalities and cost structures, and the user may select and combine various cloud services according to specific requirements.

Meanwhile, the neural network-based method and system for generating an optimized execution plan for AI workloads in hybrid and multi-cloud environments may be implemented in various platform forms such as applications, software, and websites.

Hereinafter, with reference to the accompanying drawings, a more detailed description will be given regarding the neural network-based system for generating an optimized execution plan for AI workloads in hybrid and multi-cloud environments according to the disclosure.

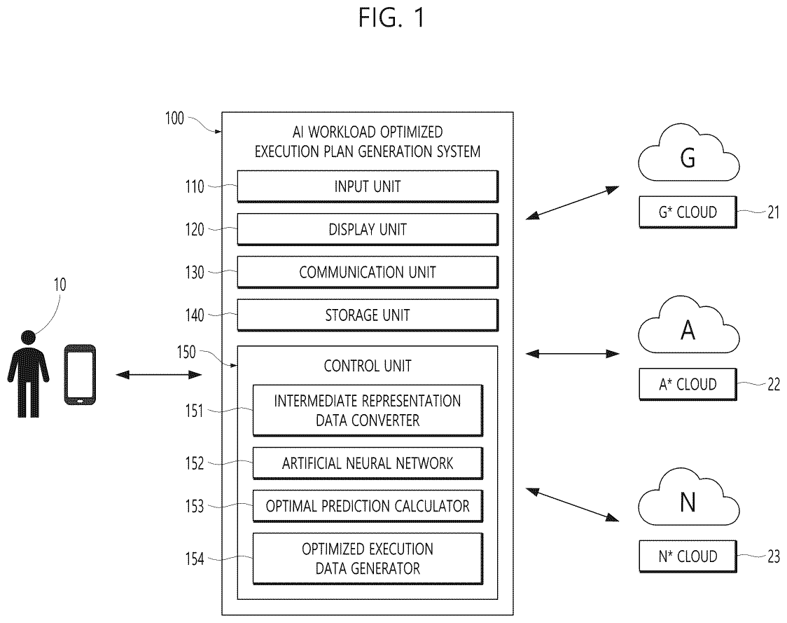

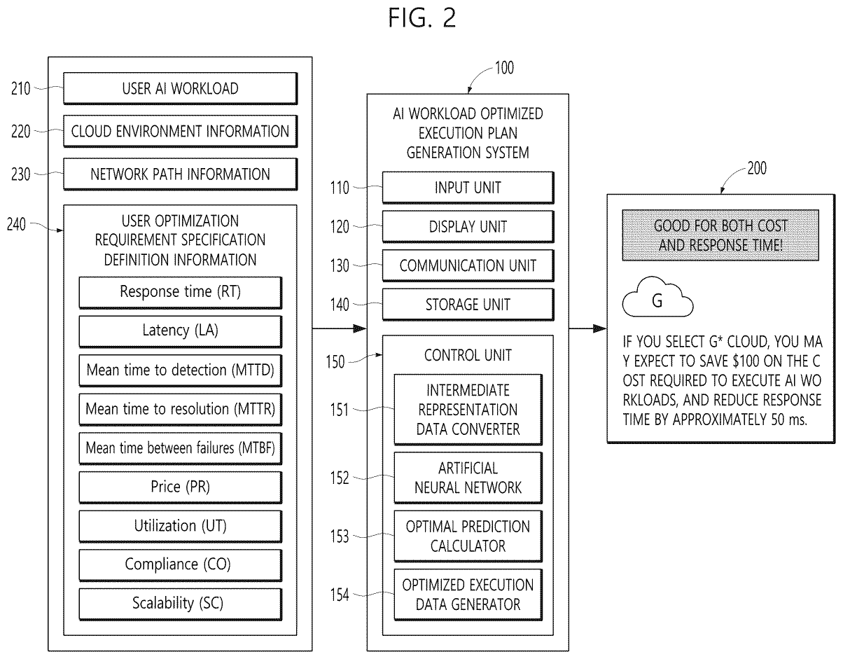

FIGS. 1 and 2 are conceptual diagrams for describing a neural network-based system for generating an optimized execution plan for AI workloads in hybrid and multi-cloud environments (hereinafter referred to as “AI workload optimized execution plan generation system”) according to the disclosure.

With reference to FIG. 1, the AI workload optimized execution plan generation system 100 according to the disclosure may include at least one component of an input unit 110, a display unit 120, a communication unit 130, a storage unit 140, or a control unit 150.

The input unit 110 may receive user input through the components of the input unit provided in the user terminal 10 (e.g., a touch screen, virtual key, physical key (or hardware button), input sensor, microphone, etc.).

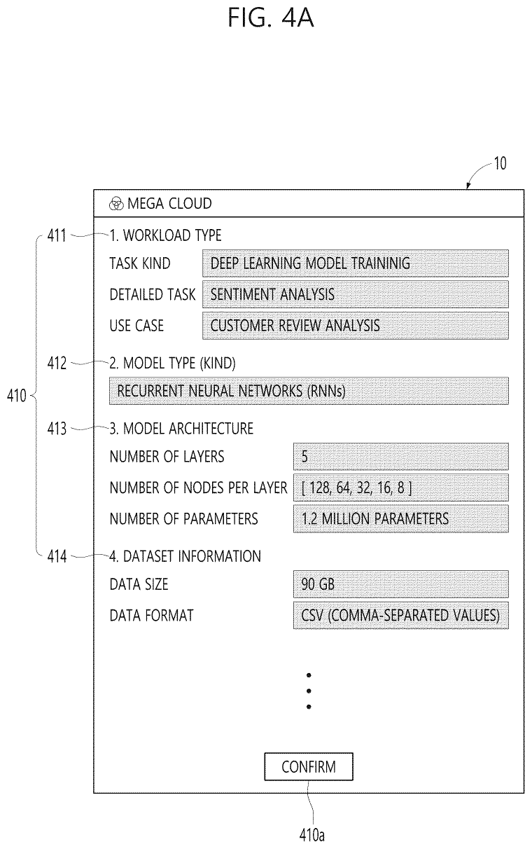

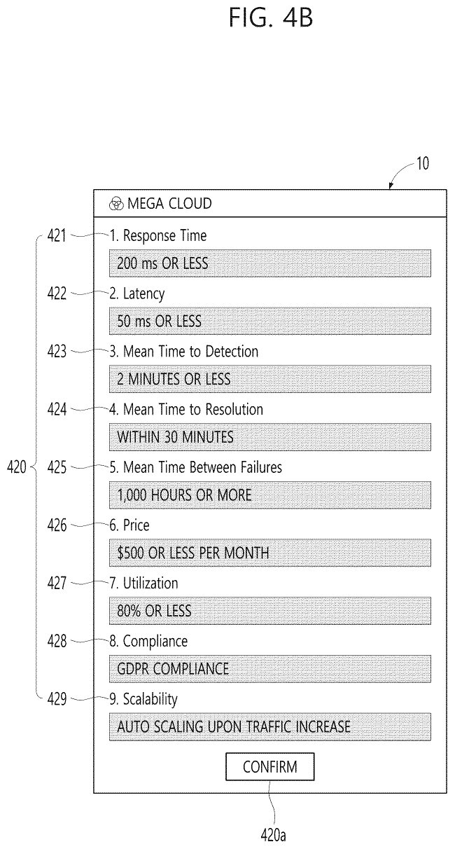

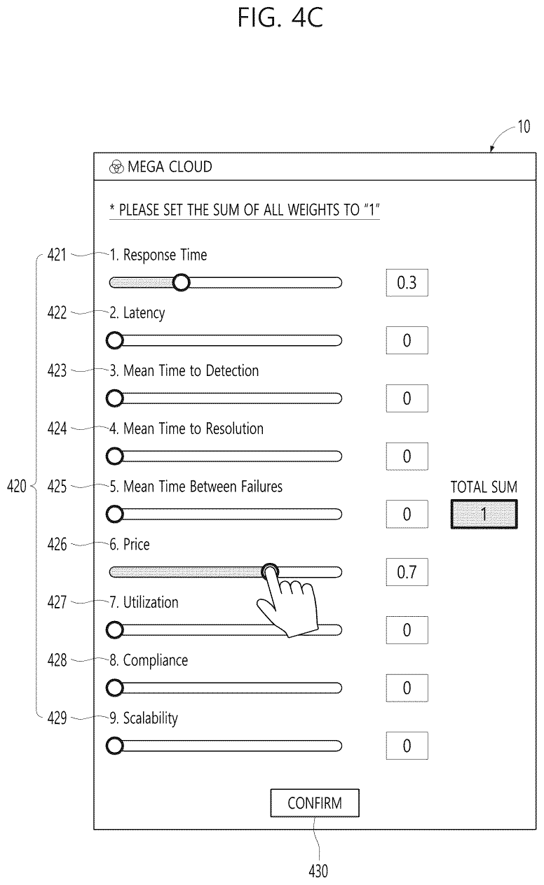

Specifically, the input unit 110 may be configured to receive, as input (or selection), the user's response regarding the user AI workload definition information and the user optimization requirement specification information by using the components of the input unit provided in the user terminal 10. Here, “receiving as input” may mean receiving an input signal (or selection signal or user input) corresponding to the user input when the user input is performed through the components of the input unit provided in the user terminal 10. For example, as illustrated in FIGS. 4A and 4B, the input unit 110 may receive user AI workload definition information 410 and user optimization requirement specification information 420 input from the user through the user terminal 10.

Further, the display unit 120 may output information through the components of the display unit provided in the user terminal 10 (e.g., an output unit, touch screen, speaker, etc.). In this case, the display unit 120 may perform both a role of outputting information and a role of receiving information as input. For example, as illustrated in FIGS. 4A and 4B, the display unit 120 may output a page (or screen) for receiving input from the user regarding the user AI workload definition information 410 and the user optimization requirement specification information 420.

In this case, the input unit and the display unit of the user terminal 10 may exist independently of each other or may exist integrally, such as a touch screen. In a case where the input unit and the display unit exist integrally, such as a touch screen, the input unit may be understood as a detection unit that detects input (e.g., touch input or scroll input, etc.) through the display unit, and as a component of the display unit.

Hereinafter, regardless of whether the input unit and the display unit of the user terminal 10 are not distinguished separately as to whether they exist independently or exist integrally, a component performing the function of receiving information as input will be referred to as the input unit, and a component performing the function of outputting information will be referred to as the display unit.

The communication unit 130 may be connected via a wired or wireless network to the user terminal 10, cloud service providers (or cloud service provider servers 21, 22, 23), external servers, and one or more networks, etc. and may be configured to transmit or receive overall data and information required for the operation of the AI workload optimized execution plan generation system 100.

Here, the user terminal 10 may include at least one of a mobile phone, smartphone, notebook computer, laptop computer, slate PC, tablet PC, ultrabook, desktop computer, digital broadcasting terminal, personal digital assistant (PDA), portable multimedia player (PMP), navigation, or wearable device (e.g., smartwatch, smart glass, head-mounted display (HMD)).

In this regard, the communication unit 130 may receive the user response (or response data) regarding the user AI workload definition information 410 and the user optimization requirement specification information 420 through the user terminal 10.

In addition, the communication unit 130 may be communicatively connected to each of a plurality of cloud service providers 21, 22, and 23 that provide different cloud (e.g., heterogeneous clouds) environments, and may receive different cloud environment information related to the cloud computing infrastructures provided by each of the plurality of cloud service providers 21, 22, and 23.

Further, the communication unit 130 may support various communication methods depending on the communication standard of the communicating device.

For example, the communication unit 130 may be configured to communicate with a communication target using at least one of WLAN (Wireless LAN), Wi-Fi (Wireless Fidelity), Wi-Fi Direct, DLNA (Digital Living Network Alliance), WiBro (Wireless Broadband), WiMAX (World Interoperability for Microwave Access), HSDPA (High Speed Downlink Packet Access), HSUPA (High Speed Uplink Packet Access), LTE (Long Term Evolution), LTE-A (Long Term Evolution-Advanced), 5G (5th Generation Mobile Telecommunication), Bluetooth™ Frequency Identification, infrared communication (Infrared Data Association; IrDA), UWB (Ultra-Wideband), ZigBee, NFC (Near Field Communication), Wi-Fi Direct, or Wireless USB (Wireless Universal Serial Bus) technology.

Meanwhile, the storage unit 140, which may be referred to as a “database (DB)” or “memory,” may be configured to store various types of information related to the disclosure. In the disclosure, the storage unit 140 may be provided in the AI workload optimized execution plan generation system 100 itself. In addition, at least a portion of the storage unit 140 may be configured as a cloud server (or cloud storage). That is, the storage unit 140 may be understood that it is sufficient for the storage unit 140 to be a space in which the information necessary for the operation of the AI workload optimized execution plan generation system 100 according to the disclosure is stored, and there is no restriction on the physical space.

The aforementioned user may have a pre-registered account in the AI workload optimized execution plan generation system 100 according to the disclosure. In this case, the account may be generated through a page (or screen) linked with the AI workload optimized execution plan generation system 100. Alternatively, the account may be generated in at least one other system linked with the AI workload optimized execution plan generation system 100. However, in this specification, without separately distinguishing the system 100 in which the user account is issued, all accounts that may use various services provided by the AI workload optimized execution plan generation system 100 according to the disclosure are to be referred to as “pre-registered account in the AI workload optimized execution plan generation system.”

Accordingly, the storage unit 140 may store various types of information related to the user account.

Here, the information related to the user account may include user history information.

More specifically, the user history information may include information related to various events that have occurred under the user account. For example, the events that occur under the user account may include at least one of i) input of AI workload definition information, ii) input of optimization requirement specification information, or iii) setting of weights for the optimization requirement specification information, which is required to execute a specific AI workload.

Accordingly, the user history information may include, for example, at least one of i) an input record (or history or details) of the AI workload definition information input by the user, ii) an input record of the optimization requirement specification information input by the user, iii) a record of the user's weight setting for the optimization requirement specification information, iv) a record of the user's AI workload execution, v) details of cloud environment setting information recommended (or suggested) to the user, or vi) the user's cloud environment setting information (or cloud environment information used by the user).

The aforementioned user may include a specific enterprise (or company or business entity). In the disclosure, a user who does not have an account (non-member) may also use various services provided by the disclosure.

In addition, the storage unit 140 may store data and instructions necessary for the operation of the AI workload optimized execution plan generation system 100 according to the disclosure. For example, the storage unit 140 may store training datasets required for training an artificial neural network (or artificial intelligence model) 152, and may also store data to be processed or being processed by the control unit 150, as well as software, firmware, program code (or source code), and instructions.

Further, the storage unit 140 may store different cloud environment information related to the cloud computing infrastructures provided by each of the plurality of cloud service providers 21, 22, and 23. In another example, the storage unit 140 may store different network path information related to network performance and network transmission paths required for transmitting and receiving data in different cloud environments.

Meanwhile, the control unit 150, which may also be referred to as a “processor,” may perform a role of controlling the overall operation of the AI workload optimized execution plan generation system 100 related to the disclosure. The control unit 150 may process signals, data, information, etc. that are input or output through the above-described constituent elements, or may perform a series of data processing operations to provide or handle appropriate information and functions for the user.

As illustrated in FIG. 2, the control unit 150 may, in order to recommend (or suggest) to the user a cloud service that satisfies the user's requirement conditions, generate (or calculate) input data used for recommending the cloud service.

First, the control unit 150 may receive input regarding user AI workload definition information 210 and user optimization requirement specification definition information 240 from the user terminal 10.

Here, the user AI workload definition information 210 may include elements that have different characteristics (or meanings) in relation to the AI workload type (or kind), artificial intelligence model type, and data characteristics.

In addition, the user optimization requirement specification definition information 240 may include elements that have different characteristics in relation to time, price, and resource utilization required (or used) to execute the user AI workload definition information. For example, the user optimization requirement specification definition information 240 may include at least one of response time, latency, mean time to detection, mean time to resolution, mean time between failures, price, utilization, compliance, or scalability. However, the elements included in the user optimization requirement specification information in the disclosure are not limited thereto, and various additional elements may be further included beyond those mentioned above.

Further, the control unit 150 may extract necessary information (e.g., workload type, dataset characteristics, artificial intelligence model type, hyperparameters, etc.) from the user AI workload definition information 210.

Next, the control unit 150 may sample cloud environment information 220 and network path information 230 stored in the storage unit 140, and may collect N data pairs (or data sets or sample group data) in which the cloud environment information 220 and the network path information 230 are paired.

Further, the control unit 150 may combine the information extracted from the user AI workload definition information with each of the N data pairs in which the cloud environment information 220 and the network path information 230 are paired, and may generate N sample group data corresponding to the N data pairs and including the extracted user AI workload definition information. More specifically, for one user AI workload definition information 210, there may exist N data pairs in which the cloud environment information 220 and the network path information 230 are paired, and N sample group data (input data) may be generated through the combination thereof.

The control unit 150 may perform validation and preprocessing procedures on the N sample group data and may calculate input data (N sample group data) that has been preprocessed.

Meanwhile, the control unit 150 may convert different environmental information (e.g., parameter names, kinds and combinations of resources, etc.) collected from on-premises and heterogeneous clouds into a unified expression. More specifically, the control unit 150 may convert the N sample group data that has been preprocessed into N intermediate expressions (or intermediate representations) using an intermediate representation data converter 151.

In addition, the control unit 150 may remove noise and perform normalization regarding the converted N intermediate expressions. This may be understood as a preprocessing procedure for preventing overfitting that degrades the generalization performance of the artificial neural network 152 and adjusting all attributes (or features) of the input data (N intermediate expressions) to the same scale.

Next, the control unit 150 may input the N intermediate expressions, for which noise removal and normalization have been completed, into the artificial neural network 152. In this case, the artificial neural network 152 may be executed in each environment for the N intermediate expressions, and the calculations may be performed in parallel N times, which is a number of times corresponding to the number N. Accordingly, the artificial neural network 152 may output N predicted values for the elements of the user optimization requirement specification information (e.g., time, price, etc.) expected to be required for executing the user AI workload definition information 210 under each of the different environments (e.g., cloud environment, network environment).

Then, the control unit 150 may specify an optimal predicted value using an optimal prediction calculator (or optimal prediction calculation) 153. The optimal prediction calculator 153 may receive the N predicted values, which is output data from the artificial neural network 152, as input and may calculate a final score for the N optimal predicted values based on the input N predicted values and the user optimization requirement specification definition information 240, and sort the N optimal predicted values based on the final score. The user may select one of the N optimal predicted values. Alternatively, the AI workload optimized execution plan generation system 100 itself may specify the optimal predicted value (Top-1) having the highest score and provide it to the user so that the user does not have to make a separate selection.

Upon completion of specifying the optimal predicted value, the control unit 150 may use an optimized execution data generator 154 to identify the intermediate expression corresponding to the specified optimal predicted value, identify the cloud environment information and network path information corresponding the identified intermediate expression, and then generate final optimized execution data using the identified cloud environment and network path information.

Further, the control unit 150 may, based on the optimal predicted value, specify at least one cloud environment setting information that satisfies the user's requirement conditions (user AI workload definition information and user optimization requirement specification information), and recommend the specified cloud environment setting information to the user. For example, as illustrated in FIG. 2, the control unit 150 may provide recommendation information 200 (e.g., “Good for both price and response time!”, “If you select G* Cloud, you may expect to save $100 on the cost required to execute AI workloads, and reduce response time by approximately 50 ms.”) including the cloud environment setting information satisfying the user's requirement conditions to the user terminal 10.

However, it should be noted that the intermediate representation data converter 151, the artificial neural network 152, the optimal prediction calculator 153, or the optimized execution data generator 154 is one component of the control unit 150, and for convenience of description, may be collectively described as the control unit 150 hereinafter.

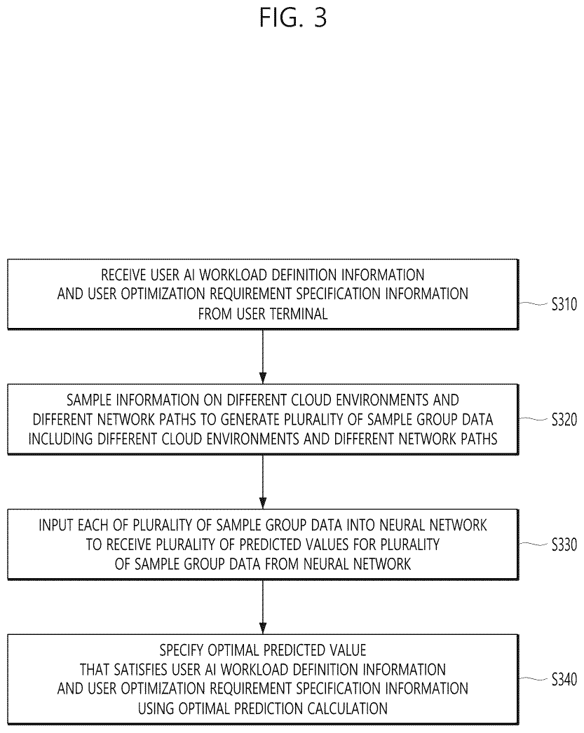

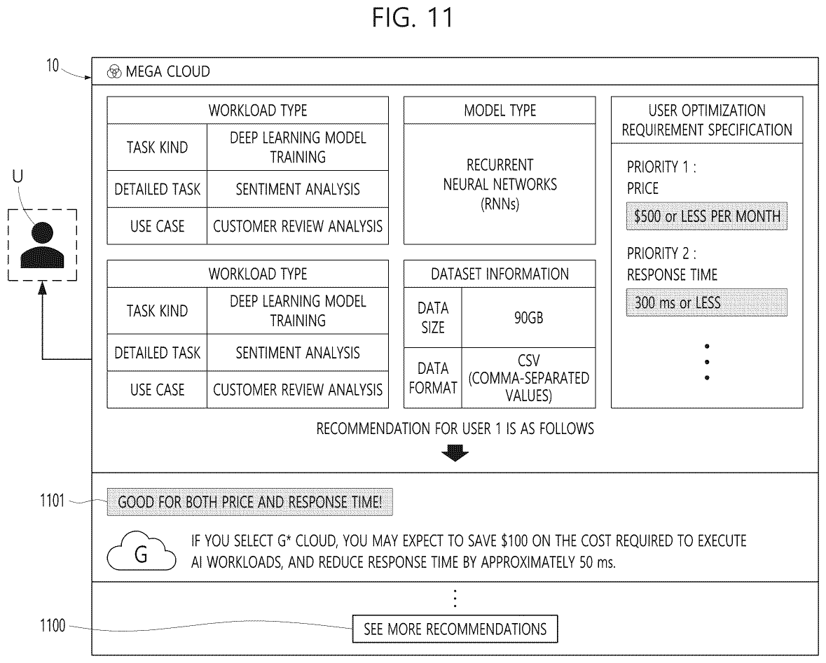

Hereinafter, based on the configuration of the AI workload optimized execution plan generation system 100 described above, a more detailed description will be given regarding the neural network-based method of generating an optimized execution plan for AI workloads in hybrid and multi-cloud environments according to the disclosure. FIG. 3 is a flowchart for describing a neural network-based method of generating an optimized execution plan for AI workloads in hybrid and multi-cloud environments according to the disclosure, FIGS. 4A, 4B, 4C, 5, 6, 7, 8, 9A, 9B, and 10 are conceptual diagrams for describing a neural network-based method of generating an optimized execution plan for AI workloads in hybrid and multi-cloud environments according to the disclosure, and FIGS. 11, 12, and 13 are conceptual diagrams for describing a method of recommending cloud environment setting information to the user according to the disclosure.

In the disclosure, a process may be performed of receiving user AI workload definition information and user optimization requirement specification information from the user terminal (S310, see FIG. 3).

The control unit 150 may provide a user environment that allows the user to input AI workload definition information and optimization requirement specification information. For example, as illustrated in FIGS. 4A and 4B, the control unit 150 may provide a page (or screen), on the user terminal 10, configured to allow the user to input the user AI workload definition information 410 and user optimization requirement specification information 420.

As described above, the user AI workload definition information 410 may include elements that have different meanings in relation to AI workload type, AI model type, and dataset characteristics. For example, as illustrated in FIG. 4A, the user AI workload definition information 410 may include at least one of workload type (e.g., “task kind,” “detailed task,” “use case,” 411), artificial intelligence model type 412, artificial intelligence model architecture (e.g., “number of layers,” “number of nodes per layer,” “number of parameters,” 413), or dataset information (e.g., “data size,” “data format,” 414).

The control unit 150 may receive the user AI workload definition information 410 from the user terminal 10. For example, the control unit 150 may receive user input corresponding to the elements with different characteristics (e.g., “task kind: deep learning model training,” “detailed task: sentiment analysis,” “use case: customer review analysis,” “model type (kind): recurrent neural networks (RNNs),” “number of layers: 5,” “number of nodes per layer: [128, 64, 32, 16, 8],” “number of parameters: 1.2 million parameters,” “data size: 90 GB,” and “data format: comma-separated values (CSV)”, 411, 412, 413, 414) included in the user AI workload definition information 410, based on the selection of a graphic object (e.g., “Confirm”, 410a) linked with the reception function of the user AI workload definition information 410 from the user terminal 10. Additionally, as described above, the user optimization requirement specification information 420 may include elements with different characteristics related to time, price, and resource utilization required (or used) to execute the user AI workload definition information 410. For example, as illustrated in FIG. 4B, the user optimization requirement specification information 420 may include at least one of response time 421, latency 422, mean time to detection 423, mean time to resolution 424, mean time between failures 425, price 426, utilization 427, compliance 428, or scalability 429.

Further, the control unit 150 may receive the user optimization requirement specification information 420 from the user terminal 10. For example, the control unit 150 may receive, from the user terminal 10, user input corresponding to the elements with different characteristics (e.g., “response time: 200 ms or less,” “latency: 50 ms or less,” “mean time to detection: 2 minutes or less,” “mean time to resolution: within 30 minutes,” “mean time between failures: 1000 hours or more,” “price: $500 or less per month,” “utilization: 80% or less,” “compliance: GDPR-compliant,” and “scalability: auto-scale when traffic increases”, 421, 422, 423, 424, 425, 426, 427, 428, 429) included in the user optimization requirement specification information 420 based on the selection of a graphic object (e.g., “Confirm”, 420a) linked with the reception function of the user optimization requirement specification information 420.

Meanwhile, the control unit 150 may receive, from the user terminal 10, settings of weights for the elements 421, 422, 423, 424, 425, 426, 427, 428, and 429 with different characteristics included in the user optimization requirement specification information 420.

To this end, the control unit 150 may provide a user environment that enables the user to set weights for the elements 421, 422, 423, 424, 425, 426, 427, 428, and 429 with different characteristics. For example, as illustrated in FIG. 4C, the control unit 150 may provide graphic objects (e.g., sliders) linked with the function to enable setting weights for each of the different elements 421, 422, 423, 424, 425, 426, 427, 428, and 429. The user may adjust the slider left or right to increase or decrease the weight of each element. In this case, the total sum of the weights may be set to always be fixed to a preset value (e.g., “1”).

However, the method of setting weights by the user in the disclosure is not limited thereto, and a user environment may be provided that allows the user to set the weights through a variety of methods other than those mentioned (e.g., check boxes, text boxes for direct numeric input, voice, drop-down menus, etc.).

Further, the control unit 150 may receive weight setting information (or user input related to weight setting) for the elements 421, 422, 423, 424, 425, 426, 427, 428, 429 with different characteristics from the user terminal 10. For example, the control unit 150 may receive weight setting information of the user including “1. response time: 0.3” and “6 and price: 0.7” based on the selection of a graphic object (e.g., “Confirm”, 430) linked with weight reception from the user terminal 10.

Alternatively, the weights of the elements 421, 422, 423, 424, 425, 426, 427, 428, and 429 with different characteristics may also be set by the AI workload optimized execution plan generation system 100 itself. For example, the control unit 150 may set the weights of the elements 421, 422, 423, 424, 425, 426, 427, 428, and 429 with different characteristics based on information (e.g., history information) of a user account logged into the user terminal 10. More specific details will be described below.

Meanwhile, in the disclosure, a process may be performed of sampling information on different cloud environments and different network paths to generate a plurality of sample group data including different cloud environments and different network paths (S320, see FIG. 3).

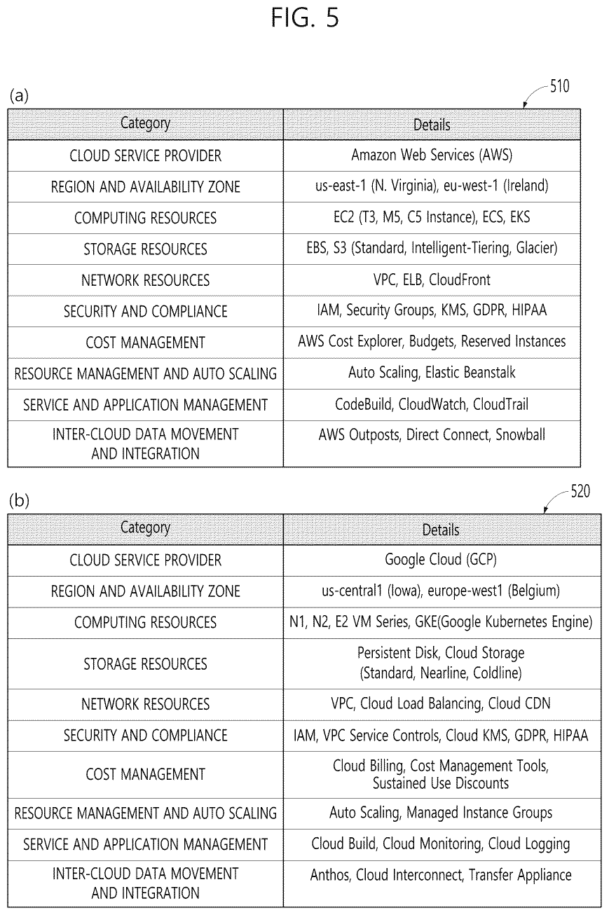

As described above, different cloud environment information (e.g., heterogeneous cloud) may include elements with different characteristics related to the cloud computing infrastructure provided by different cloud service providers. For example, as illustrated in (a) of FIG. 5 and (b) of FIG. 5, the elements with different characteristics included in the different cloud environment information may include at least one of cloud service provider, region and availability zone, computing resources, storage resources, network resources, security and compliance, cost management, resource management and auto-scaling, service and application management, or inter-cloud data movement and integration. In this case, among the different cloud environment information 510 and 520, first cloud environment information 510 may include elements related to the cloud computing infrastructure provided by a first cloud service provider (e.g., amazon web services (AWS)), and second cloud environment information 520 may include elements related to the cloud computing infrastructure provided by a second cloud service provider (e.g., google cloud (GCP)).

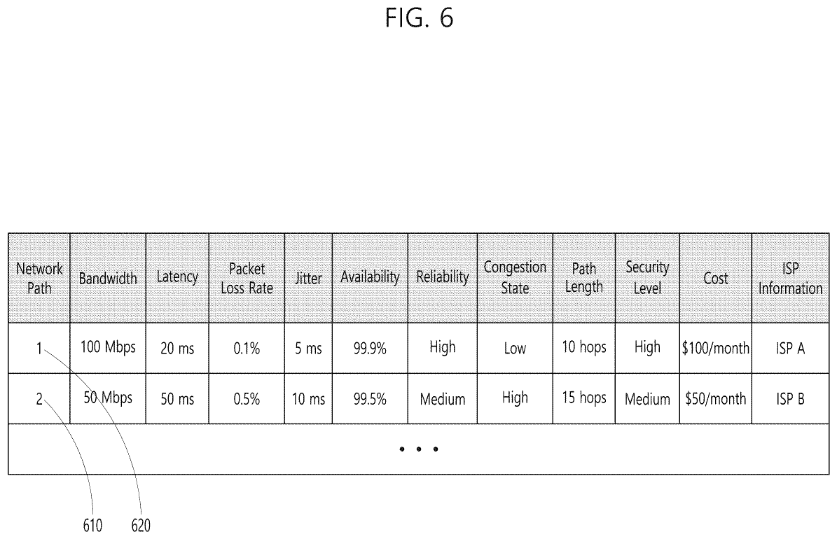

In addition, as described above, the network path information may include elements with different characteristics related to network performance and network transmission paths required for transmitting and receiving data in cloud environments (or in different cloud environments or different network environments). For example, as illustrated in FIG. 6, different network path information 610 and 620 may include at least one of network location (or region), network bandwidth, latency, packet loss rate, jitter, availability, reliability, congestion state, path length, security level, cost, or ISP information.

However, the elements included in the different cloud environment information and different network path information in the disclosure are not limited thereto, and various elements beyond those described above may be further included.

Meanwhile, the control unit 150 may sample different cloud environment information 510 and 520 and different network path information 610 and 620 previously stored in the AI workload optimized execution plan generation system 100, and may collect (or generate) N sample group data in which the different cloud environment information 510 and 520 and the different network path information 610 and 620 are paired. As another example, the control unit 150 may sample cloud environment information 510 and 520 and different network path information 610 and 620 received (or collected) from a server interlocked with the AI workload optimized execution plan generation system 100 (e.g., a cloud service provider), and generate N sample group data in which the different cloud environment information 510 and 520 and the different network path information 610 and 620 are paired.

The control unit 150 may generate a plurality of sample group data by combining each of the sampled different cloud environment information 510 and 520 and different network path information 610 and 620 with the user AI workload definition information 410, based on the user AI workload definition information 410.

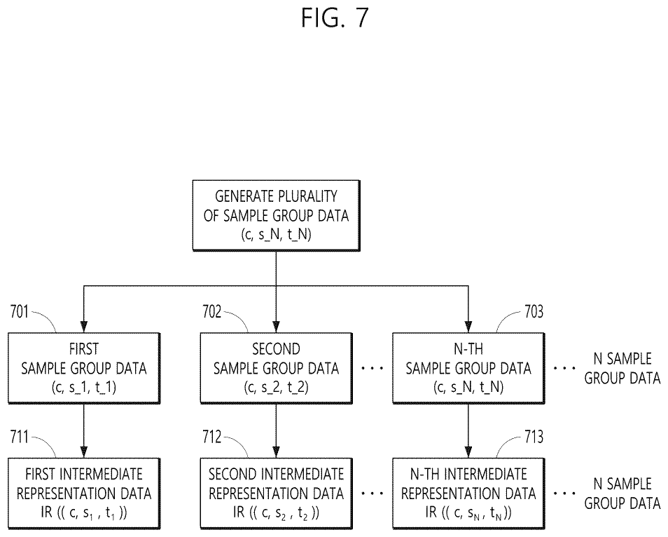

More specifically, when there are N sample group data in which different cloud environment information 510 and 520 and different network path information 610 and 620 are paired, the control unit 150 may replicate one user AI workload definition information 410 to correspond to the N sample group data, and may generate N sample group data including the user AI workload definition information 410, the different cloud environment information 510 and 520, and the different network path information 610 and 620. For example, as illustrated in FIG. 7, the control unit 150 may generate a plurality of sample group data 701, 702, and 703 including the user AI workload definition information 410, the different cloud environment information 510 and 520, and the different network path information 610 and 620.

Here, “c” may refer to the user AI workload definition information, “s” may refer to the cloud environment information, and “t” may refer to the network path information. This may be understood as generating N 3-tuples (user AI workload definition information c, cloud environment information s, and network path information t) by replicating the above c N times, with N 2-tuples (pairs of cloud environment information s and network path information t) to match the one user AI workload definition information c.

That is, the control unit 150 may combine each of the plurality (N) of sample group data in which the collected different cloud environment information 510 and 520 and the different network path information 610 and 620 are paired with the user AI workload definition information 410 to generate the plurality of sample group data 701, 702, and 703 that further includes the different cloud environment information and the different network path information, as well as the user AI workload definition information.

Further, the control unit 150 may perform validation on the generated plurality of sample group data 701, 702, and 703. As an example, the validation on the plurality of sample group data may be understood as validating whether a NULL value exists in the plurality of sample group data.

However, the validation process in the disclosure may also be performed during the reception of the user AI workload definition information and the user optimization requirement specification information. As an example, the control unit 150 may perform validation on whether an appropriate user response corresponding to each of the elements included in the user AI workload definition information and the user optimization requirement specification information has been input (e.g., for the model type, whether information on the model has been input, for the data format, whether the data format has been input that is suitable for the workload type and model type, etc.).

Meanwhile, in the disclosure, a process may be performed in which each of the plurality of sample group data is input into a neural network, and a plurality of predicted values for the plurality of sample group data is received from the neural network (S330, see FIG. 3).

The control unit 150 may input each of the plurality of sample group data 701, 702, and 703 that has been preprocessed (e.g., validated) into the artificial neural network 152.

In this case, the control unit 150 may convert the plurality of sample group data 701, 702, and 703 that has been preprocessed into a plurality of intermediate representation data using the intermediate representation data converter 151.

In this case, the number of intermediate representation data to be converted may be converted by a number corresponding to the number (N) of the plurality of sample group data 701, 702, and 703. For example, assuming that the number of the plurality of sample group data is “10”, the number of intermediate representation data to be converted may be 10.

The control unit 150 may convert each of the plurality of sample group data 701, 702, and 703 into a plurality of intermediate representation data based on a preset format. For example, as illustrated in FIG. 7, the control unit 150 may convert the first sample group data (e.g., ““(c, s_1, t_1)”, 701) into a first intermediate representation data (e.g., IR((c, s₁, t₁)), 711), convert the second sample group data (e.g., “(c, s_2, t_2)”, 702) into a second intermediate representation data (e.g., IR ((c, s₂, t₂)), 712), and convert the N-th sample group data (e.g., “(c, s_{N}, t_{N})”, 703) into an N-th intermediate representation data (e.g., IR((c, s_{N}, t_{N})), 713).

That is, as described above, in the disclosure, through the intermediate representation data conversion process, generality that sufficiently expresses information of heterogeneous systems (hybrid and multi-cloud environments) may be secured, and data representation efficiency that drives effective learning and inference of the neural network model may be achieved.

Further, the control unit 150 may remove noise and perform normalization on the plurality of converted intermediate representation data 711, 712, and 713. This may be understood as a preprocessing procedure that prevents overfitting, which degrades the generalization performance of the artificial neural network 152, and adjusts all attributes (or features) of the input data (e.g., the plurality of intermediate representation data) to the same scale.

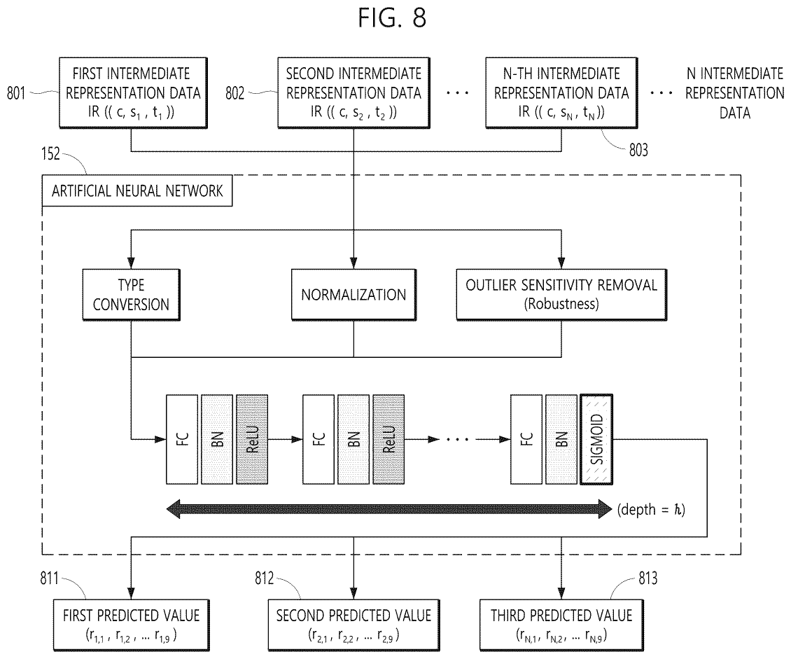

For example, as illustrated in FIG. 8, since all input data for the artificial neural network 152 need to be defined as real numbers, the control unit 150 may perform a type conversion process to convert any data having Boolean values into real numbers when data with Boolean values exists. However, when no input data with Boolean values exists, the type conversion process may not be performed.

Further, the control unit 150 may perform normalization and outlier sensitivity reduction (robustness) processes on the plurality of intermediate representation data sets 711, 712, and 713. For example, the value range and variability may differ depending on the information in the input data. When the range of latency (LA) values is “[0.0, 1.0]”, the range of price (PR) values may be “[0.0, 20,000,000]”. In addition, outliers present in the input data may affect the performance of the artificial neural network 152.

The techniques (or methods) used for normalization and outlier sensitivity reduction in the disclosure may be confirmed with reference to the normalization method table and equation described in the following figure.

| Normalization Method | Feature |
|---|---|
| min-max normalization | [0, 1], outlier-sensitive |
| Standardization(Z-score normalization) | No boundary, outlier-sensitive |
| Median absolute deviation | No boundary, outlier-insensitive |
| Tanh-estimator | Outlier-insensitive |
| Gaussian Rank scaler | Generally more effective than the |
| | first two methods |

[Representative] Tanh-estimator:
${x}_{norm} = \frac{1}{2} [ tanh [ \frac{0.01 ( x - μ )}{δ} ] + 1 ]$

Meanwhile, the control unit 150 may input each of the plurality of intermediate representation data that has been preprocessed into the artificial neural network 152. For example, as illustrated in FIG. 8, the control unit 150 may input the first intermediate representation data 801, the second intermediate representation data 802, and the N-th intermediate representation data 803, which have been preprocessed, into the artificial neural network 152.

In this case, the architecture of the artificial neural network 152 in the disclosure may be confirmed with reference to the table and equation described in the following figure.

Neural Network Architecture

Basic fully connected (FC) Architecture
Autoencoder (AE)-based SVM regression
Variational autoencoder (VAE)-based regression
(e.g., Semi-supervised VAE for regression, or SSVAER)
[Representative] Basic FC Architecture
One hidden layer is constructed by combining a FC layer,
batch normalization (BN), and a rectified linear unit (ReLU),
and the number (depth) of corresponding hidden layers is set
as an adjustable parameter h according to the actual
implementation and experiment of the method.
Final activation function (e.g., sigmoid function ƒ ∈(0, 1))

In this regard, the artificial neural network 152 may perform prediction for each of the plurality of intermediate representation data 801, 802, and 803, and may output a plurality of predicted values for each of the plurality of intermediate representation data. In this case, the artificial neural network 152 may perform prediction in parallel for each of the plurality of intermediate representation data 801, 802, and 803, and may simultaneously output the plurality of predicted values for each of the plurality of intermediate representation data 801, 802, and 803. For example, the artificial neural network 152 may perform predictions in parallel for the first intermediate representation data 801, the second intermediate representation data 802, and the N-th intermediate representation data 803, and may simultaneously output the first predicted value (e.g., (r_{1,1}, r_{1,2}, . . . r_{1,9}), 811) for the first intermediate representation data 801, the second predicted value (e.g., r_{2,1}, r_{2,2}, . . . r_{2,9}), 812) for the second intermediate representation data 802, and the N-th predicted value (e.g., (r_{N,1}, r_{N,2}, . . . r_{N,9}), 813) for the N-th intermediate representation data 803.

Here, r_{k,l} may be the prediction (or inference) value of the artificial neural network 152 for the l-th user optimization requirement corresponding to the k-th input. All output values (r_{k,l}) are results to which the same activation function is applied and thus have the same range. In the disclosure, a sigmoid function, which is one kind of activation function, is applied, and all output values have a range of (0, 1).

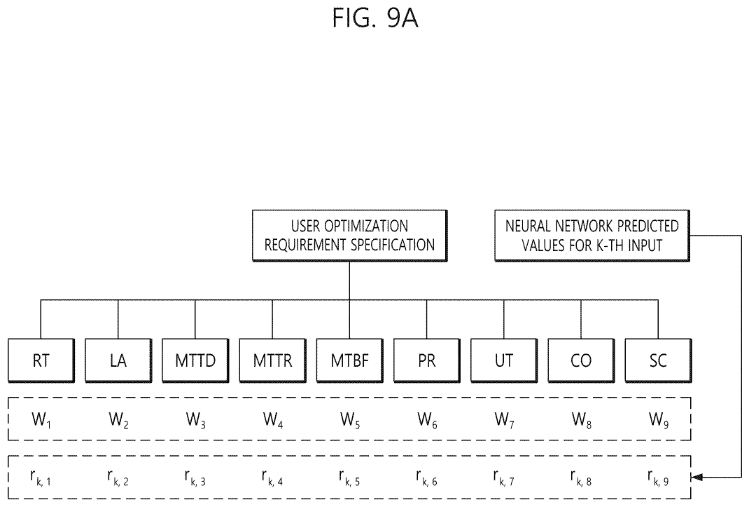

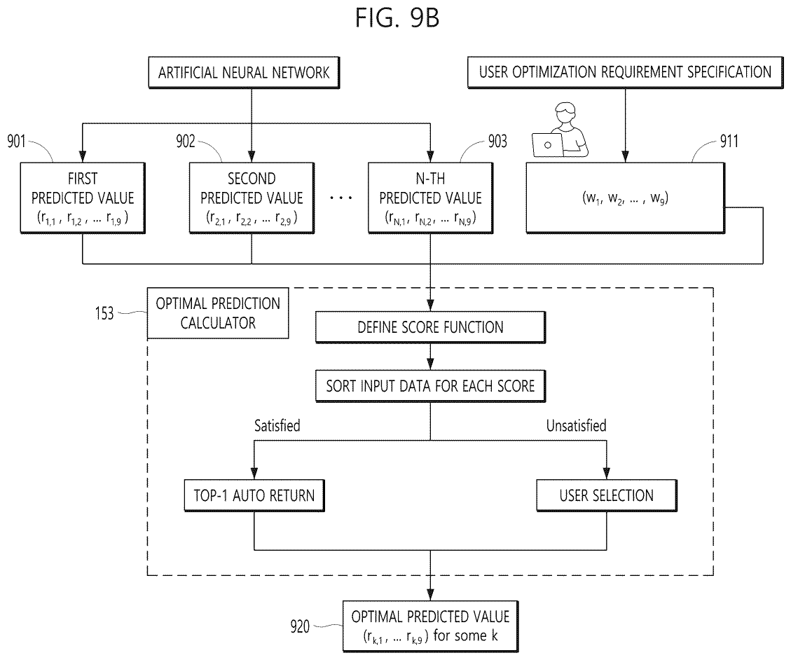

This is a measure taken to prevent the intention of the user optimization requirement specification information 420, which is defined as weights (e.g., (w₁, . . . , w₉), from being diluted during the optimal prediction calculation process to be described below. For example, when (w₁, w₂)=(0.3, 0.6), (r_{1,1}, f_{1,2})=(2,000, 0.3), and other input-output patterns are similar, the first optimization element may dominate the score calculation (see FIG. 9A).

Further, the plurality of predicted values 811, 812, and 813 output from the artificial neural network 152 may include the time and price required to execute the user AI workload definition information 410 under different cloud environment information 510 and 520 and different network path information 610 and 620. However, the information included in the plurality of predicted values 811, 812, and 813 is not limited thereto, and may further include the resource utilization used to execute the user AI workload definition information.

That is, since there are a total of N intermediate representation data 801, 802, and 803 for the user AI workload definition information 410, the control unit 150 may apply the neural network N times to one user AI workload and may receive (or acquire) N predicted values including time and price, from the corresponding results.

Meanwhile, in the disclosure, a process may be performed of specifying an optimal predicted value that satisfies the user AI workload definition information and the user optimization requirement specification information using an optimal prediction calculation (S340, see FIG. 3).

The control unit 150 may receive, as input, the plurality of predicted values 811, 812, and 813 output by the artificial neural network 152 for the user AI workload definition information 410 and the user optimization requirement specification information 420, and may calculate (or specify) at least one predicted value satisfying the user-specified requirements (e.g., the AI workload definition information and the optimization requirement specification information).

As described above, the user optimization requirement specification information 420 may include elements with different characteristics, and the control unit 150 may receive settings of weights for the elements 421, 422, 423, 424, 425, 426, 427, 428, and 429 with different characteristics, from the user terminal 10.

With reference to FIG. 9A, r_{k,l} may indicate the inference result (e.g., k∈{1, 2, . . . , N} and l∈{1, 2, . . . , 9}, r_{k,l}∈(0, 1) for the l-th requirement corresponding to the k-th intermediate representation data (input data).

The control unit 150 may specify an optimal predicted value satisfying the user AI workload definition information 410 and the user optimization requirement specification information 420 using an optimal prediction calculation (or optimal prediction calculator).

Specifically, as illustrated in FIG. 9B, the control unit 150 may input the plurality of predicted values 901, 902, and 903 output from the artificial neural network 152, and the weights (e.g., (w₁, w₂, . . . , w₉), 911) for the elements with different characteristics received from the user terminal 10, into the optimal prediction calculator 153.

First, the optimal prediction calculator 153 may define a score function based on the plurality of predicted values 901, 902, and 903 and the weights 911 corresponding to the elements with different characteristics. In this case, for the convenience of explanation, the disclosure will be described by assuming that a plurality (e.g., seven) of elements among the elements described as an example of the user optimization requirement specification information (thus, there are also seven corresponding weights). The score function for the k-th output of the artificial neural network 152 may be expressed as in [Equation 1] below.

$$𝒮 ( {w}_{1 : 7} , {r}_{k , 1 : 7} ) := {w}_{7} \times {r}_{k , 7} - {\sum }_{i = 1}^{6} {w}_{i} \times {r}_{k , i} \qquad [ Equation 1 ]$$

Next, the optimal prediction calculator 153 may calculate the score function and sort the plurality of optimal predicted values for each of the calculated scores. For example, a plurality of optimal prediction (or inference) values may be calculated through the calculation of the score function, and the plurality of optimal predicted values may be sorted in descending order.

Further, the control unit 150 may specify an optimal predicted value (e.g., (r_{k,1}, . . . , r_{k,9}) for some k, 920) that satisfies the user AI workload definition information 410 and the user optimization requirement specification information 420, among the sorted plurality of optimal predicted values.

In this case, the specified optimal predicted value 920 may correspond to either an optimal predicted value specified by the AI workload optimized execution plan generation system 100 or an optimal predicted value specified based on the user's selection.

In this regard, the user's primary objective, in the step of specifying the optimal predicted value described above, is to identify the optimal predicted value that yields the maximum score (i.e., (r_{k,1}, . . . r_{k,9}) for the specific k that yields the maximum score), and subsequently, in the optimized execution data generation step, to finally identify the corresponding input data.

Therefore, the control unit 150 may specify the optimal predicted value (Top-1) having the maximum score (Top-1 automatic return).

However, after confirming the plurality of optimal predicted values (r_{k,1:9} for all k∈{1, 2, . . . , N}), the user may arbitrarily select one optimal predicted value, regardless of the weight w of the user optimization requirement specification information 420 (user selection).

More specific details regarding the “Top-1 automatic return” and “user selection” may be confirmed with reference to the table and equation described in the following figure. However, the disclosure is not limited to any particular method of specifying the optimal predicted value.

| Optimal Predicted | |
|---|---|
| Value Selection Method | Description |
| Top-1 Auto Return | Return rₖ = (r_{k, 1}, r_{k, 2}, . . . , r_{k, 9}) such that k ∈ {1, 2, . . . , N} maximizes |
| | S(w, NN(lR((c, sₖ, tₖ)))), where rₖ = NN(lR((c, sₖ, tₖ))). |
| User Selection | Return rₖ = (r_{k, 1}, r_{k, 2}, . . . , r_{k, 9}) for k such that the user likes rₖ |
| | the most. |

As described above, the control unit 150 may calculate the optimal predicted value 920 that satisfies the user AI workload definition information 410 and the user optimization requirement specification information 420, using the plurality of predicted values 901, 902, and 903 and the weights 911 of the user optimization requirement specification information.

The optimal prediction calculation described above may be designed to reflect the user optimization requirement specification information, and may be configured to have a “weight” mechanism, while also allowing the user to confirm the inference results and make manual selections regardless of the specified weights.

Meanwhile, in the disclosure, the optimized execution data may be generated based on the optimal predicted value 920.

More specifically, in the present disclosure, the optimized execution data generation may be used to identify (specify) backwards the cloud environment setting information that yielded the optimal predicted value 920, and generate the optimized execution data using the identified cloud environment setting information.

The cloud environment setting information may include the cloud environment and network path information (information related to the setting of the cloud environment) necessary to execute a specific AI workload (e.g., a user AI workload), and may include the values set for optimized execution of the corresponding workload.

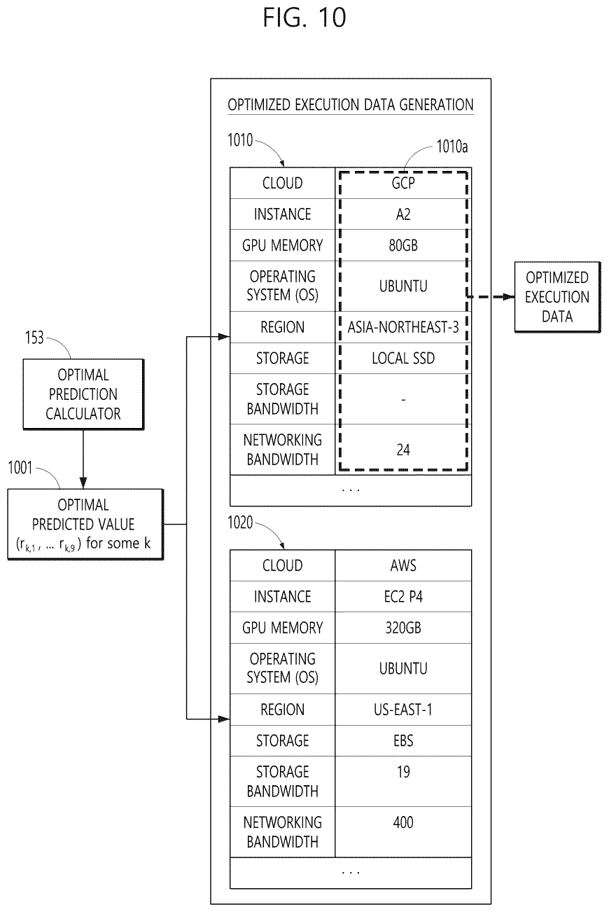

As illustrated in FIG. 10, the control unit 150 may first confirm the optimal predicted value 1001 specified using the optimal prediction calculation. This means acquiring information on the expected optimal time and price required to execute the user's AI workload (user AI workload definition information). With this as a starting point, the control unit 150 may identify backwards the intermediate representation data that yielded the corresponding optimal predicted value 1001, and then identify backwards the specific cloud environment information and specific network path information included in the sample group data corresponding to the identified intermediate representation data.

Next, based on the result of the calculation of the optimal predicted value 1001, the control unit 150 may identify (or specify) backwards the intermediate representation data that yielded the corresponding optimal predicted value. For example, the control unit 150 may identify the intermediate representation data 1010 for the optimized execution data based on the optimal predicted value 1001. However, as an example, for the intermediate representation data, multiple intermediate representation data 1010 and 1020 may be identified, not necessarily just one.

Further, the control unit 150 may convert the identified intermediate representation data 1010 into final optimized execution data. More specifically, the control unit 150 may combine each of the cloud environment information and the network path information 1010a included in the intermediate representation data 1010 to generate the optimized execution data (or execution command). As an example, the optimized execution data may be generated in the form of a program code (or source code). However, the form of the optimized execution data in the disclosure is not limited thereto and may be implemented in various other forms beyond those mentioned.

Meanwhile, based on the process of the AI workload optimized execution plan generation system 100 as described above, the disclosure may provide a user environment for recommending an optimal cloud environment that satisfies the user's requirement conditions (e.g., the user AI workload, the user optimization requirement specification, etc.).

To this end, the control unit 150 may first specify at least one cloud environment setting information that satisfies the user AI workload definition information 410 and the user optimization requirement specification information 420, based on the optimal predicted value 1001. For example, through the calculation of the optimal predicted value 1001, the control unit 150 may analyze various cloud environments and network paths related to the user AI workload definition information 410 to calculate the expected time and expected price, and based on the calculation results, specify the cloud environment setting information that satisfies the user AI workload definition information 410 and the user optimization requirement specification information 420.

As an example, the cloud environment setting information may include at least one of the cloud service provider, instance type and configuration (e.g., CPU, GPU, and memory specifications), storage options (e.g., SSD, HDD), network settings (e.g., network bandwidth and latency, etc.), operating system and software environment (e.g., Windows, Linux, Python, TensorFlow, etc.), cost management information (expected cost, spot instance, reserved instance, etc.), or performance information (e.g., expected execution time, expected resource utilization). However, the elements included in the cloud environment setting information are not limited thereto and may further include other elements with different characteristics beyond those mentioned.

Next, the control unit 150 may generate recommendation information for the specified cloud environment setting information.

The “recommendation information” described in the disclosure may include the expected time and expected price required to execute the AI workload defined by the user (user AI workload definition information) in the specified cloud environment setting information. In this case, the recommendation information may further include information on the expected resource utilization used to execute the AI workload defined by the user, in addition to the expected time and expected price.

Further, the control unit 150 may provide the generated recommendation information to the user terminal 10. For example, as illustrated in FIG. 11, the control unit 150 may provide, on the user terminal (or service page 10) into which the user account U is logged, the recommendation information 1101 for the cloud environment setting information (e.g., “Good on both price and response time!”, “If you select G* Cloud, you may expect to save $100 on the cost required to execute the AI workload and reduce response time by approximately 50 ms.”).

Meanwhile, in the disclosure, the recommendation information provided to the user terminal 10 may be provided with a plurality of recommendation information having different types (or characteristics).

Specifically, the plurality of recommendation information having different types may include a first type of recommendation information specified based on the user optimization requirement specification information 420, and a second type of recommendation information specified based on preset conditions in the AI workload optimized execution plan generation system 100. However, in the disclosure, the types are not necessarily limited to the first type and second type. Here, the first type of recommendation information may be recommendation information provided based on weights set for the elements 421, 422, 423, 424, 425, 426, 427, 428, and 429 with different characteristics included in the user optimization requirement specification information 420. For example, assuming that weights for “response time” and “price” were set by the user terminal 10, the control unit 150 may provide the recommendation information 1101 that satisfies the user AI workload definition information 410 and the weights for response time and price.

Additionally, the second type of recommendation information may be recommendation information that the AI workload optimized execution plan generation system 100 itself specifies and provides to the user (or user account U).

In this regard, preset conditions for providing the second type of recommendation information may be set and exist in the AI workload optimized execution plan generation system 100. For example, in the AI workload optimized execution plan generation system 100, the preset conditions may be set and exist based on as least one of: i) information matched to the user account U (e.g., user history information); ii) specific cloud environment setting information that was selected most frequently during a specific time period (or preset time period); or iii) cloud environment setting information of a plurality of users registered in the AI workload optimized execution plan generation system 100. However, the criteria for setting the preset conditions are not limited thereto, and may further include various other criteria in addition to those mentioned.

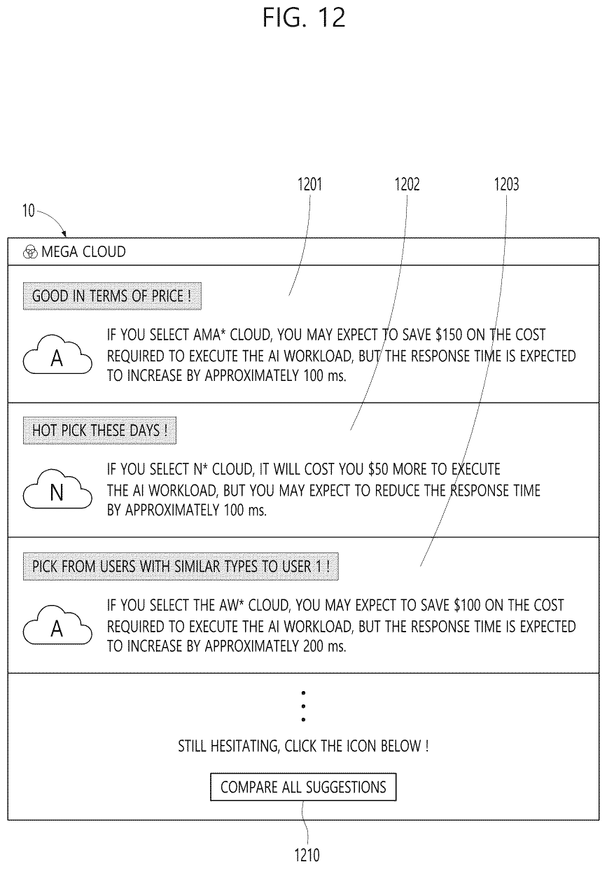

The control unit 150 may provide the second type of recommendation information to the user terminal 10, to which the first type of recommendation information 1101 has been provided, based on the preset conditions. For example, as illustrated in FIGS. 11 and 12, the control unit 150 may, based on the selection of a graphic object (e.g., “See more recommendations”, 1110) linked with the function of providing the second type of recommendation information from the user terminal 10, provide the second type of recommendation information 1201, 1202, and 1203 to the user terminal 10.

As an example, among the second type of recommendation information 1201, 1202, and 1203, first recommendation information (e.g., “Good in terms of price!”, “If you select Ama* Cloud, you may expect to save $150 on the cost required to execute the AI workload, but the response time is expected to increase by approximately 100 ms.”, 1201) may be recommendation information provided based on the history information of the user account U. This may be provided based on the weights the user set in the past or preferred elements, among the weights for the elements included in the user optimization requirement specification information.

As another example, among the second type of recommendation information 1201, 1202, and 1203, second recommendation information (e.g., “HOT pick these days!”, “If you select N* cloud, it will cost you $50 more to execute the AI workload, but you may expect to reduce the response time by approximately 100 ms”, 1202) may be provided based on the specific cloud environment setting information that was selected most frequently during a specific time period.

As yet another example, among the second type of recommendation information 1201, 1202, and 1203, third recommendation information (e.g., “Pick from users with similar types to User 1!”, “If you select the AW* cloud, you may expect to save $100 on the cost required to execute the AI workload, but the response time is expected to increase by approximately 200 ms”, 1203) may be provided based on cloud environment setting information of a plurality of users registered in the AI workload optimized execution plan generation system 100.

Further, the control unit 150 may sequentially sort the plurality of specified recommendation information and provide it to the user terminal 10.

Here “sequentially sorting and providing” may be understood as providing the recommendation information specified in plurality by sorting the plurality of recommendation information in order of priority based on the user optimization requirement specification information.

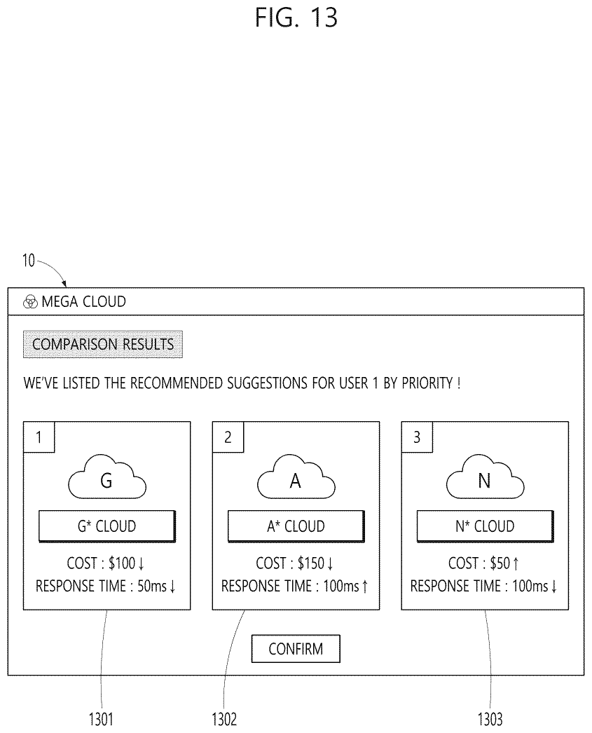

For example, as illustrated in FIGS. 12 and 13, the control unit 150 may, based on the selection of a graphic object (e.g., “Compare all suggestions”, 1210) linked with the function of sorting the plurality of recommendation information from the user terminal 10, sequentially list the plurality of recommendation information 1301, 1302, and 1303 in order of priority and provide it to the user terminal 10.

Meanwhile, the control unit 150 may receive a selection of at least one of the plurality of recommendation information from the user terminal 10.

Specifically, the control unit 150 may receive the user's selection for any one of the first type of recommendation information or second type of recommendation information from the user terminal 10. For example, as illustrated in FIG. 13, the control unit 150 may receive the user's selection for the first recommendation information 1301 among the plurality of recommendation information 1301, 1302, and 1303 from the user terminal 10.

Further, the control unit 150 may generate the optimized execution data corresponding to the recommendation information recommended by the user. More specifically, the control unit 150 may generate the optimized execution data corresponding to the recommendation information selected from the user terminal 10 and register the generated optimized execution data to the user account U. For example, assuming that the first recommendation information 1301 corresponding to the first type of recommendation information was selected from the user terminal 10 as illustrated in FIG. 13, the control unit 150 may generate the optimized execution data corresponding to the first recommendation information 1301 and register it to the user account U logged into the user terminal 10.

As such, by providing both the first type of recommendation information and second type of recommendation information having different types simultaneously, the disclosure may provide a user environment in which the user may select an optimal cloud environment from various perspectives.

That is, the user may select the optimal cloud environment (cloud environment setting information) that simultaneously satisfies both time and cost required to execute the AI workload, as well as performance optimization, by being provided with not only personalized recommendation information satisfying the user's requirement conditions but also recommendation information from various perspectives.

1. A neural network-based method of generating an optimized execution plan for an AI workload in hybrid and multi-cloud environments, the method comprising:
receiving, from a user terminal, user AI workload definition information and user optimization requirement specification information;
sampling information on different cloud environments and different network paths to generate a plurality of sample group data comprising the different cloud environments and the different network paths;
inputting each of the plurality of sample group data into a neural network to receive a plurality of predicted values for the plurality of sample group data from the neural network; and
specifying an optimal predicted value that satisfies the user AI workload definition information and the user optimization requirement specification information using optimal prediction calculation,
wherein the plurality of sample group data further includes the user AI workload definition information, and
wherein the generating of the plurality of sample group data comprises:
combining, based on the user AI workload definition information, each of the sampled different cloud environment information and the different network path information with the user AI workload definition information to generate the plurality of sample group data,
the method further comprising:
converting each of the plurality of sample group data into a plurality of intermediate representation data based on a preset format; and
inputting each of the plurality of intermediate representation data into the neural network,
wherein the neural network performs prediction for each of the plurality of intermediate representation data and outputs the plurality of predicted values for each of the plurality of intermediate representation data, and
wherein the plurality of predicted values includes time and price required to execute the user AI workload definition information in the different cloud environment information and the different network path information.

2. The method of claim 1, wherein the user AI workload definition information includes information related to an AI workload type, an artificial intelligence model type, and dataset characteristics,
wherein the different cloud environment information includes information related to a cloud service provider, a cloud service location, a cloud service pricing policy, and a cloud service type, and
wherein the different network path information includes information related to network performance and network transmission paths.

3. The method of claim 1, wherein the plurality of predicted values further includes a resource utilization used to execute the user AI workload definition information, and
wherein the neural network performs the prediction for each of the plurality of intermediate representation data in parallel to simultaneously output the plurality of predicted values for each of the plurality of intermediate representation data.

4. The method of claim 1, wherein the user optimization requirement specification information includes elements with different characteristics,
wherein the elements with different characteristics further include time and the price required to execute the user AI workload definition information and resource utilization used to execute the user AI workload definition information, and
wherein the receiving of the user optimization requirement specification information further comprises:
receiving, from the user terminal, settings of weights for the elements with different characteristics.

5. The method of claim 3, wherein the optimal prediction calculation:
defines a score function based on the plurality of predicted values and weights for the elements with different characteristics;
calculates the score function to sort a plurality of optimal predicted values for each of the calculated scores; and
specifies the optimal predicted value that satisfies the user AI workload definition information and the user optimization requirement specification information among the sorted plurality of optimal predicted values.

6. The method of claim 5, further comprising:
generating optimized execution data based on the optimal predicted value.

7. The method of claim 1, further comprising:
specifying at least one cloud environment setting information that satisfies the user AI workload definition information and the user optimization requirement specification information based on the optimal predicted value;
generating recommendation information for the specified cloud environment setting information; and
providing the generated recommendation information to the user terminal.

8. The method of claim 7, wherein the recommendation information includes an expected time and an expected price required to execute the user AI workload definition information in the cloud environment setting information.

9. The method of claim 8, wherein the recommendation information further includes an expected resource utilization used to execute the user AI workload definition information in the cloud environment setting information.

10. The method of claim 7, wherein the recommendation information includes a first type of recommendation information specified based on the user optimization requirement specification information, and a second type of recommendation information specified based on preset conditions.

11. The method of claim 10, further comprising:
generating, based on a selection of one of the first type of recommendation information or the second type of recommendation information from the user terminal, optimized execution data corresponding to the selected recommendation information; and
registering the optimized execution data to a user account.

12-14. (canceled)
